(19) United States
(12) Patent Application Publication
(10) Pub. No.: US 2008/0135038 A1
(43) Pub. Date: Jun. 12, 2008

(54) Safe Grill With Double Vertical Combustion Chambers

(76) Inventors: Aude Michel, Evecquemont (FR); Luc Michel, Evecquemont (FR)

Correspondence Address: BUCHANAN, INGERSOLL & ROONEY PC, POST OFFICE BOX 1404, ALEXANDRIA, VA, 22313-1404, US

(21) Appl. No.: 11/791,741

(22) PCT Filed: Nov. 28, 2005
(86) PCT No.: PCT/FR05/02946

§ 371 Date: May 29, 2007

(30) Foreign Application Priority Data
Nov. 29, 2004 (FR) 0412613

(51) Int. Cl. A47J 37/07

(52) U.S. Cl. 126/25 A

(57) ABSTRACT

This invention relates to a safe grill designed for cooking food. Said grill is composed of double vertical combustion chambers with adjustable width, each of said combustion chambers having a single cooking face facing the food to be cooked. Said grill may be provided with a protection wall. This invention also relates to an arch connecting the two vertical combustion chambers, extensions that fold down automatically under an overload and finally a removable gas ignition. Thus, this invention is aimed at solving the problem that consists firstly of keeping the taste of food and preserving the quality of food, while enabling fast cooking of the food, and being safe for users of said grill, limiting nuisances and finally having a heat consumption consistent with the quantity of food to be cooked.

Finally this invention can transform the grill into an outdoor radiant heater and an outdoor fireplace.

This invention relates to a grill designed for cooking food with a double set of vertical combustion chambers preferably positioned longitudinally and adjustable in width, each of said combustion chambers having a single cooking face facing the food to be cooked. Said grill may be provided with a protection wall. This invention also relates to an arch connecting the two vertical combustion chambers, extensions that fold down automatically under an overload and finally a removable gas ignition. This grill is healthy, safe and fun to use.

A double set of combustion chambers refers to outside walls with the fuel containers (combustion chambers) with an adjustable front face and possibly a set of flaps forming an arch.

Grills are traditionally composed of a horizontal combustion chamber, the food being placed above the heat source or combustion chamber. This has the disadvantage that fat drops into the embers or the heating elements, which generates toxic materials that are deposited on the food and lead to the formation of flames that themselves damage the food. This deteriorates the taste of the food and introduces health risks by the creation of strongly carcinogenic compounds on the elements.

Furthermore, fat and other liquids released during cooking that come into contact with hot points generate fumes and odours that create nuisances for the environment and the neighbourhood.

Thus, two alternatives have been proposed to solve these problems in the past, namely grills confined in a closed containment and grills with a vertical combustion chamber.

Grills confined in a closed containment can control the appearance of flames and cook indirectly with a receptacle inserted between the heat source and the food. However, such a configuration prevents evacuation of smoke and tar generated by cooking and consequently contaminates the elements.

Grills with a vertical combustion chamber enable fat to drop elsewhere other than directly on the fuel and therefore do not generate flames or dangerous compounds. Furthermore, fumes do not reach the food. However, heat distribution is not uniform, with food being cooked essentially by direct radiation, leading to longer cooking time, and it is difficult to control the fuel flow, and therefore uniformity of cooking if a solid fuel such as charcoal is used. Furthermore with such grills, the fuel quantity cannot be adjusted to match the quantity of food to be cooked and therefore they are not economic.

Furthermore, none of these embodiments provides a satisfactory safety level against the risks of burns when the grill is being used.

On all existing solid fuel appliances, there is usually a non-negligible quantity of charcoal and unburned embers at the end of cooking that are allowed to burn out unused. Furthermore, the use of this grill is naturally associated with the idea of eating outside, and the temperature can drop further quickly in spring, autumn and even in the evening in the middle of the summer, thus obliging guests to add extra clothes or hosts to use parasol type outdoor radiant gas heaters. This considerably increases the investment cost, storage space, the logistics of gas cylinders and risks of accidents due to inadequate maintenance of this equipment.

Thus, this invention is aimed at solving the problem that consists firstly of keeping the taste of food, also preserving the quality of food regardless of the cooking method used, in other words food is not affected by any chemical or physical transformations that could be harmful to health, while enabling fast use of the grill and fast cooking of the food and secondly assuring safety for users of said grill, limiting nuisances and finally a heat consumption appropriate for the quantity of food to be cooked.

Furthermore, at the end of cooking or at any time whatsoever, this grill can be transformed into a large outside fireplace and radiant heater capable of heating the entire table, making use of the solid fuel consisting of the charcoal or wood not burned during cooking.

Said grill is also composed of vertical combustion chambers in which fat will drop into recovery pans and thus never touch the heating elements. Moreover, flames, smoke and combustion gases never come into contact with food.

All components that might be made dirty by cooking residues can be removed and sized so that they can be washed in the dishwasher, so that the various residues that can be noxious for health can be eliminated between each use.

Said invention is composed of two combustion chambers, each consisting of a single cooking face facing the food to be cooked. Furthermore, the spacing between the two combustion chambers is variable and the position of the food relative to these combustion chambers is itself variable. Thus, this invention can be used to obtain a controlled and uniform temperature.

Furthermore, said grill is globally in an open combustion containment, so that fumes and combustion gas can escape without coming into contact with the food. However, flaps forming a arch between the two combustion chambers and closing off the sides cause reflection of infrared radiation providing a more uniform distribution of heat, preventing losses and thus leading to a controlled and uniform temperature.

Said invention thus limits health risks generated by grills like those described in prior art.

Furthermore, such a grill with double vertical combustion chambers assuring that fat and liquids released during cooking do not drop onto the embers or the heating elements significantly limits smoke and smells, thus respecting the environment and the neighbourhood.

Said invention thus limits nuisances generated by grills like those described in prior art.

Said invention with two vertical combustion chambers arranged longitudinally and adjustable in width, and the cooking arch enable faster cooking of food, even in wet weather. Furthermore, the upper part of the container that forms the combustion chamber remains open and is widely tapered to facilitate loading of fuel during cooking, the arch simultaneously preventing added fuel from spreading on the food. Furthermore, all elements that could come into contact with food or cooking residues are removable and sized so that they can fit in a dishwasher, thus facilitating use of said grill. The presence of gas ignition enables fast ignition of the grill even in wet weather.

Said invention thus enables fast use of the grill and fast cooking of the food.

The invention composed of two vertical combustion chambers each provided with a single cooking face facing the food to be cooked and the arch limits access to hot elements. Furthermore, said grill is provided with vertical combustion chambers that are not directly accessible from the outside due to the presence of a protection wall isolated from heat sources by insulation such as air. Thus, all outside walls of the grill remain at an acceptable temperatures thus limiting risks of burns. Finally, this grill may be installed on a carriage that is made so as to be very stable. This carriage may be provided with extensions that fold down automatically under an overload, thus preventing accidental tipping of the grill, for example under the weight of a child hanging from the end of one of these extensions.

Said invention thus limits risks of home accidents due to grills like those described in prior art.

Furthermore, said grill is composed of compartmentalised combustion chambers or comprises several heating elements that can be used separately or in combination so as to modulate the heating area. In the case of solid fuels, the heating or radiant area forming the combustion chamber grill can also be displaced so as to vary the thickness of containers that form the combustion chambers, so that the fuel quantity can be varied. Such embodiments combined with the possibility of adding fuel while cooking thus enable economic use of the invention.

Finally, said grill comprises a set of combustion chambers or a combustion chamber that can slide over the entire width and a set of combustion chambers or a combustion chamber hinged on one or several vertical hinge pins so that this set of combustion chambers can pivot by approximately 180°, the two sets of combustion chambers or combustion chambers then being side by side, approximately in line with each other, making a set of radiant panels forming a large and comfortable outdoor heating system or an outdoor fireplace if solid fuel is used.

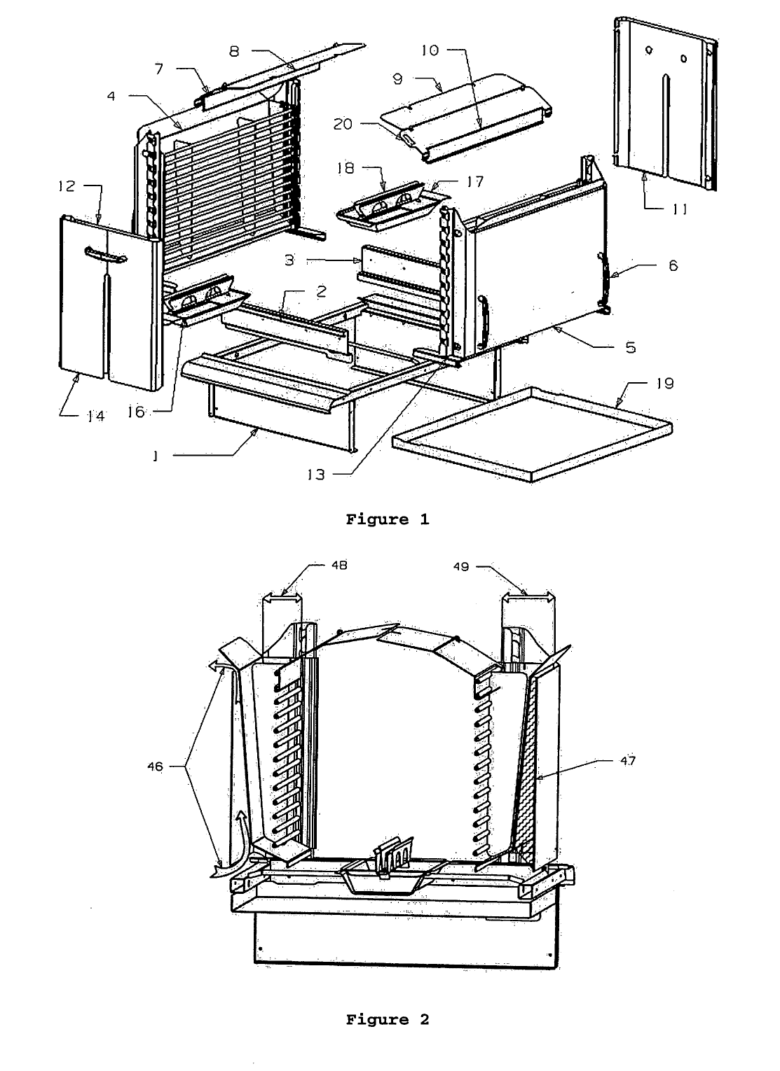

FIG. 1 shows an exploded view of the main parts of the grill body.

FIG. 2 shows a sectional view through the grill body, mainly the combustion chambers.

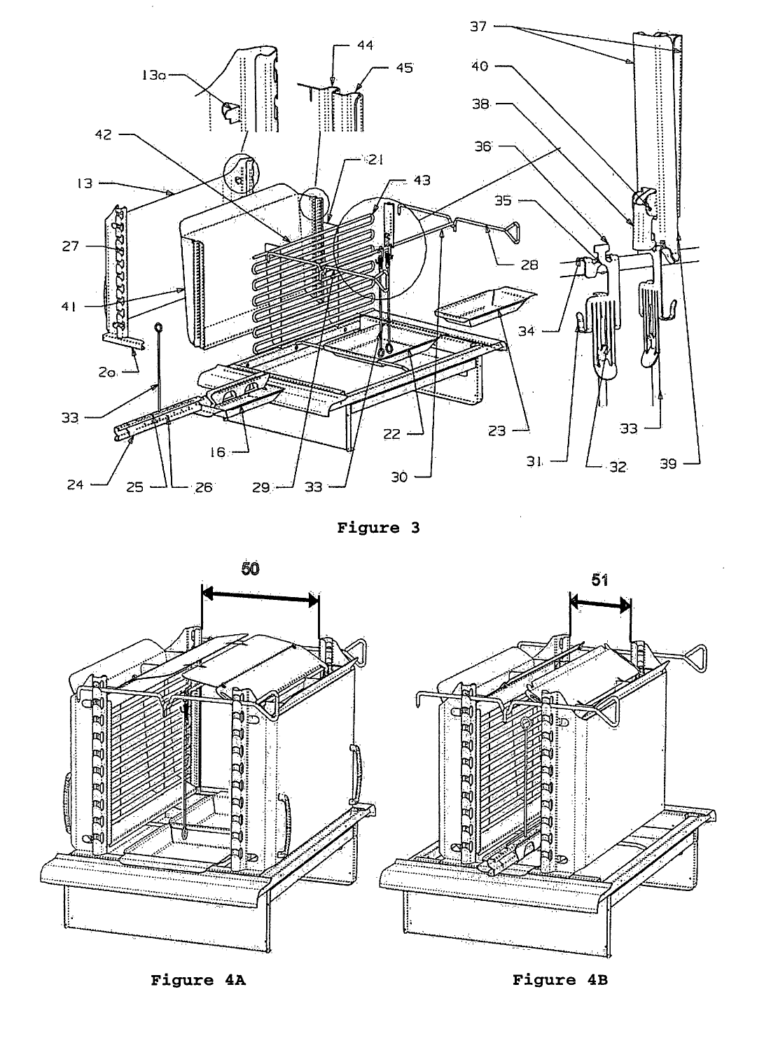

FIG. 3 shows an exploded view of a set of combustion chambers and various cooking equipment.

FIG. 4 shows a partial view of the double vertical combustion chamber with adjustable width.

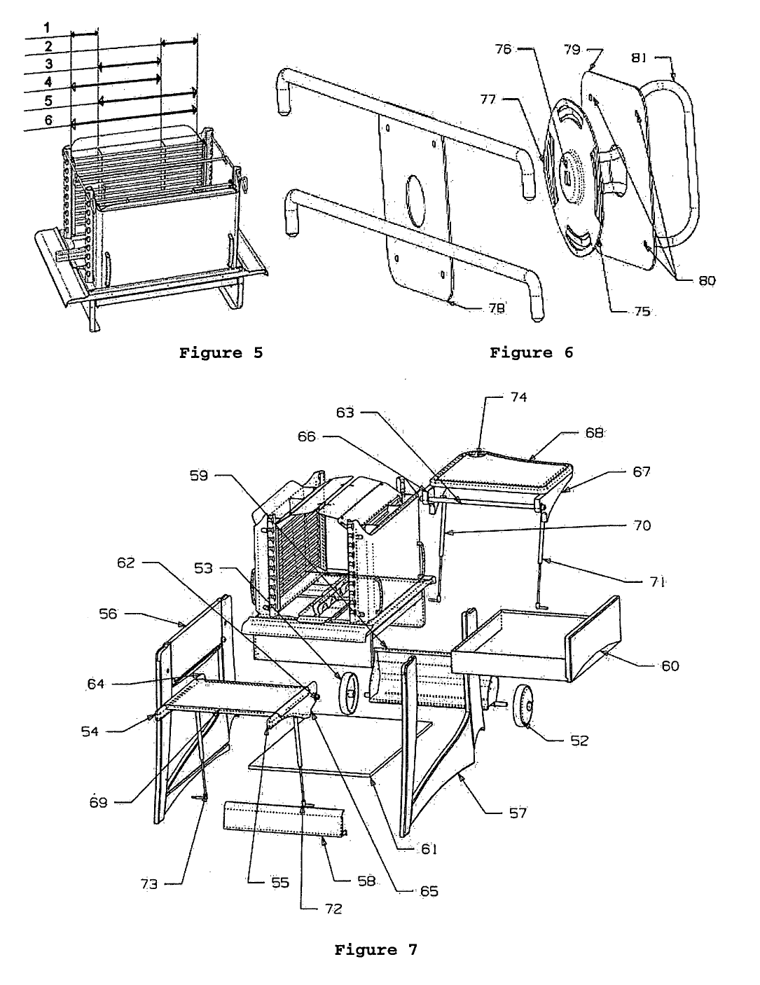

FIG. 5 shows compartmentalised combustion chambers that can be used separately or in combination so as to modulate the heating area.

FIG. 6 shows an exploded view of the spit turner support, in a manual version with brake.

FIG. 7 shows an exploded view of the grill carriage.

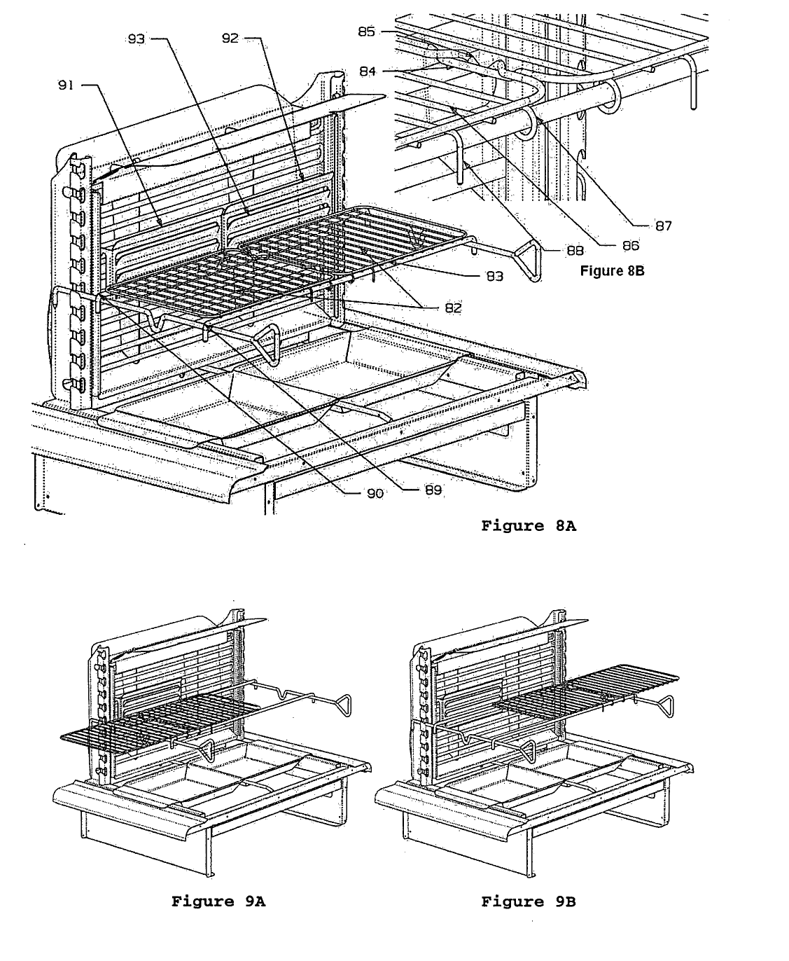

FIG. 8 shows a partial view of the grill fitted with horizontal racks.

FIG. 9 shows a partial view of the grill representing the various extended positions of the horizontal grills.

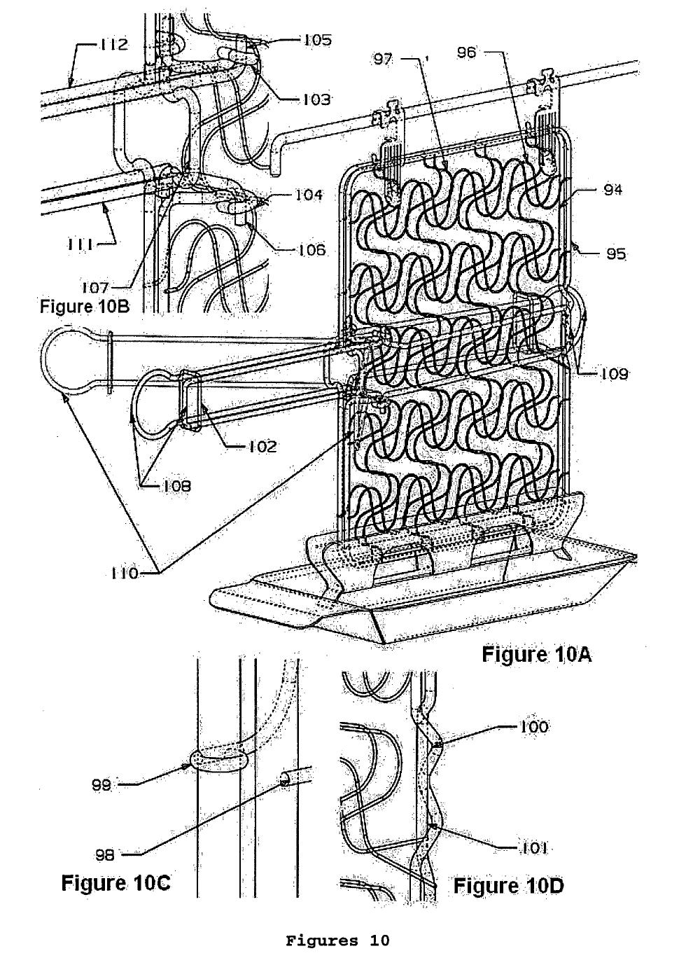

FIG. 10 shows a partial view of the grill representing a preferred embodiment of the vertical food support grills.

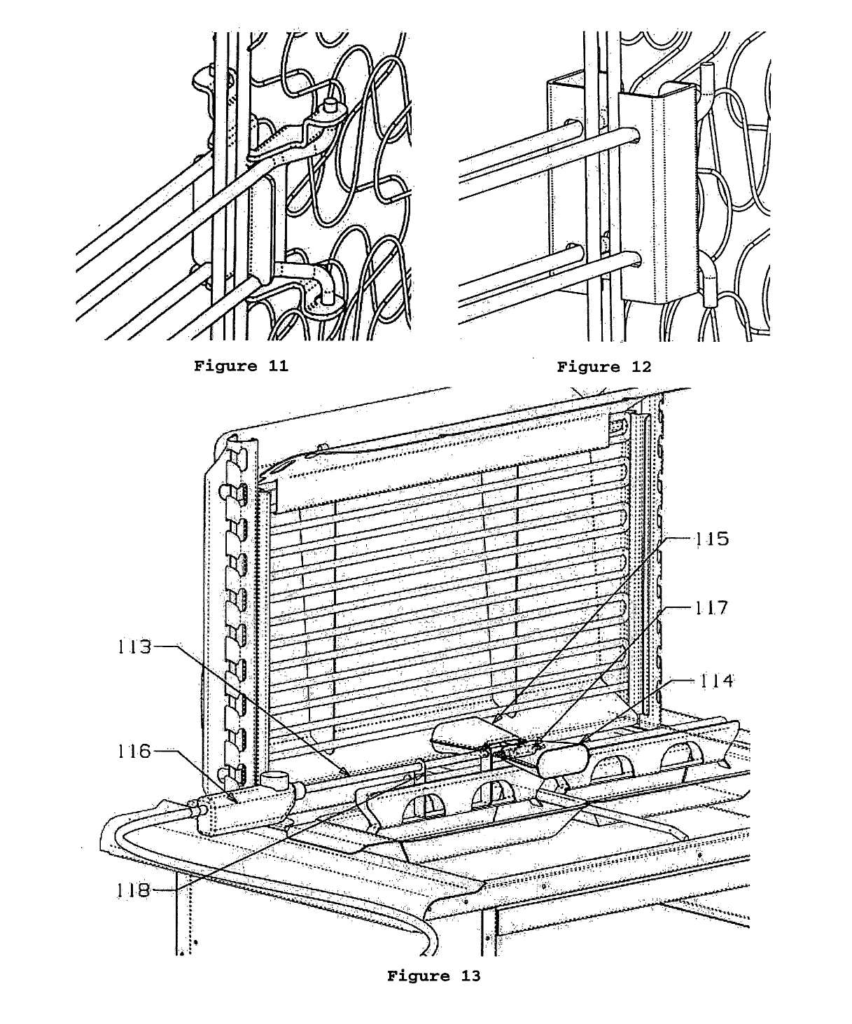

FIG. 11 shows another embodiment of the attachments of the handles for the vertical food support grills.

FIG. 12 shows another embodiment of the attachments of the handles for the vertical food support grills (sliding system).

FIG. 13 shows a partial view of the grill representing the fast removable gas ignition system.

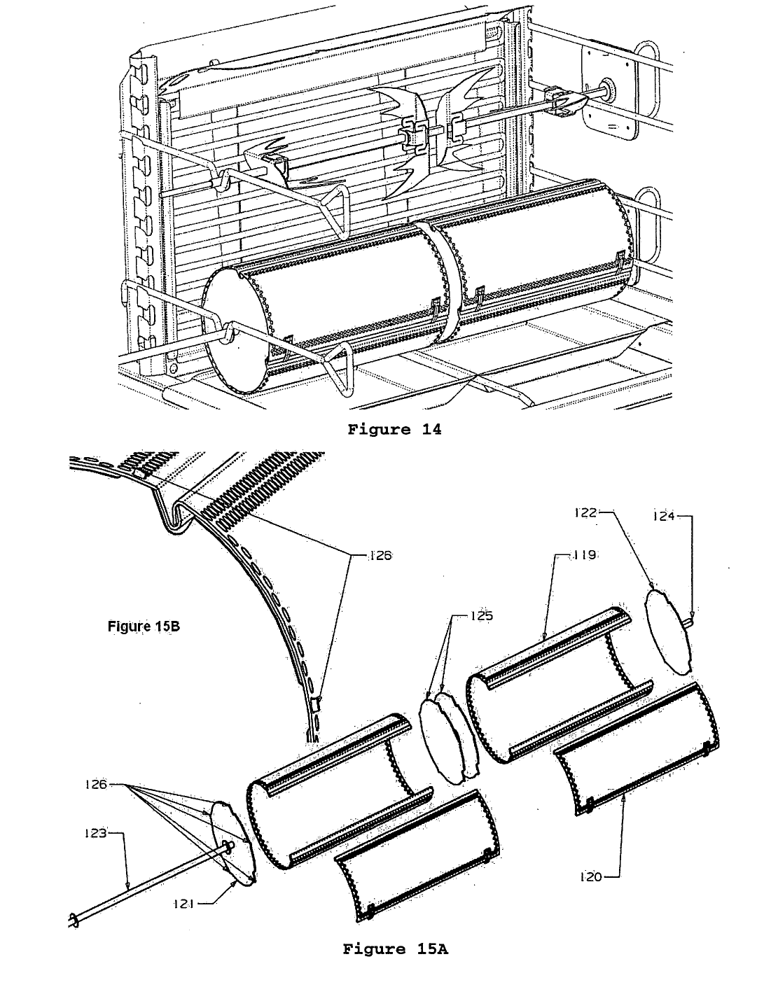

FIG. 14 is a partial view of the grill fitted with a spit and two cooking baskets.

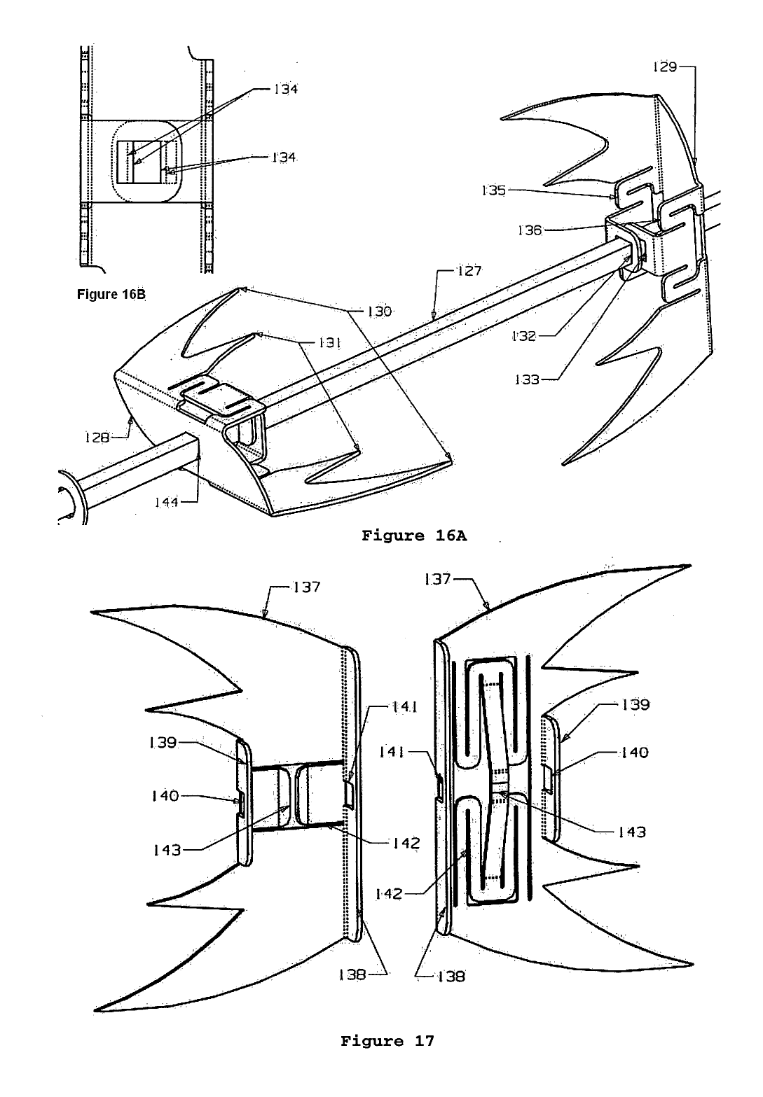

FIG. 15 is an exploded view showing details of the cooking baskets.

FIG. 16 shows a detailed view of a spit system.

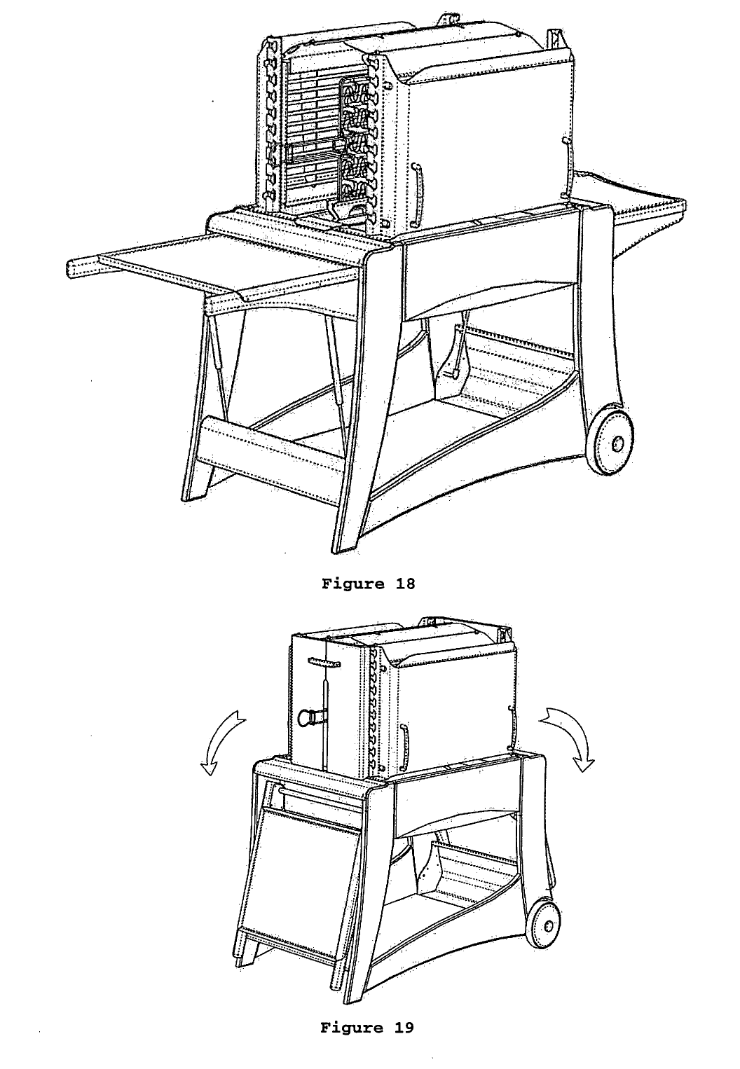

FIG. 17 shows two other embodiments of spit forks.

FIG. 18 shows a ¾ front view of the grill assembly fitted with vertical cooking racks.

FIG. 19 shows a ¾ front view of the grill assembly fitted with vertical flaps, the carriage extensions being folded down in the storage or safety position.

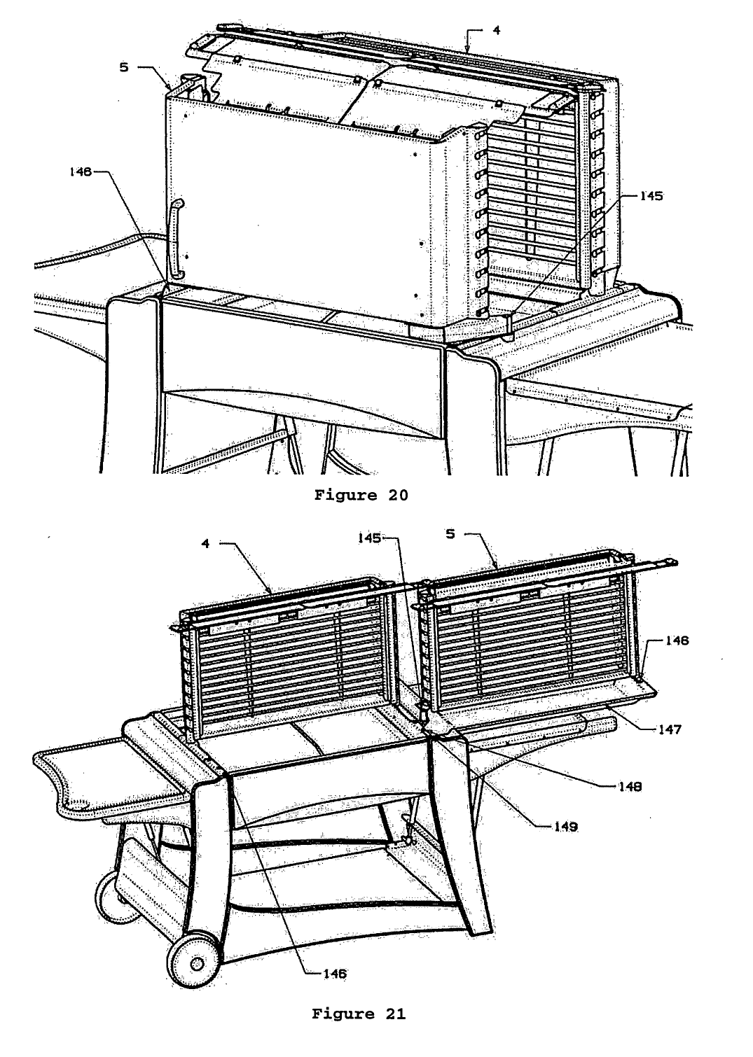

FIG. 20 shows a view of the set of combustion chambers fixed on the frame by a hinge pin

FIG. 21 shows the grill with a combustion chamber open in the outdoor radiant heating position.

Said invention consists of a grill with two vertical combustion chambers positioned longitudinally and adjustable in width. Each combustion chamber or set of combustion chambers or one of the combustion chambers or one of the combustion chamber sets can slide independently from a central position towards the outermost position (50,51). Each combustion chamber is composed of a single cooking face facing the food to be cooked.

For example, the grill is composed of a frame (1) on which two slides (2, 3) are fixed. One or two sets of combustion chambers (4, 5) are fixed on these slides. Each of these sets of combustion chambers is fitted with at least one handle to facilitate positioning (6).

Said grill is confined in a closed containment. However, their upper parts may advantageously be prolonged by one or more flaps (7, 8, 9, 10) preferably made from reflecting, removable and/or hinged materials made of one or several parts that, when extended, move towards the facing heating element so as to form an arch. Thus, the flaps may be in different positions so as to best adapt to the variable width between the two combustion chambers and so as to form variable sized openings, for example to access food. The flaps are fitted with external handles (20) so that they can be easily handled. These flaps are removable so that they can be cleaned and possibly to maintain their reflecting properties.

At their longitudinal ends, each side of the combustion chambers may be connected by vertical flaps preferably made from a reflecting material, removable and/or hinged in one or several parts so that when they are put into place, they connect the two opposite heating elements so as to form an oven and to increase reflection of radiation. One preferred embodiment will be removable vertical click fit flaps provided with an opening through which the spit turner can pass and fitted with at least one handle (11, 12).

In one preferred embodiment of the invention, said vertical combustion chambers are not directly accessible from the outside due to the presence of a protection wall (13) that is not directly in contact with said combustion chambers.

This protection wall, preferably made of metal, may be positioned on the slides (2, 2a, 3) fixed to the bottom of the grill. This wall keeps the combustion chambers in place by isolated contact points (13a), advantageously with four contact points on each side of the wall.

This wall is isolated from the combustion chambers either by an insulating material such as glass wool (47) or preferably by air, by creating fresh air circulation (46) by forming a space between the protection wall and the combustion chamber.

Similarly, the vertical flaps closing off the ends of the combustion chambers are not directly accessible from the outside due to the presence of a protection wall (14, 15) not directly in contact with said flaps except by four isolated connections or through an insulation.

Advantageously, the combustion chambers of the grill comprise at least two compartments or comprise at least two heating elements that can be used separately or in combination so as to modulate the heating area. The combustion chamber may be divided into at least two parts. Advantageously, the widths of the parts are different to increase the number of possible combinations, so that the heating area (FIG. 5) can be varied depending on the combination. When solid fuel is used for heating, a partition, for example made of metal (21) can separate the space into compartments. If gas or electric heating elements are used, the combustion chambers may be composed of several heating elements that can be ignited independently of each other.

The grill comprises at least one fat pan independent of the combustion chambers. It may be put down or suspended under or placed on a slide under the food and can thus be moved at will and is therefore removable so that it can be emptied and cleaned easily, its dimensions preferably being such that it can be washed in a dishwasher. The grill is preferably provided with two fat pans (16, 17) placed one behind the other, each with the size required for the dishwasher. The lengths and widths of the fat pans may be different (22,23) such that their size is adapted to the size of the food. These fat pans are preferably made from a reflecting material and also form a reflecting material that better distributes radiation and heat.

Said fat pan is preferably provided with a U-shaped support facing upwards (18) to hold the skewer support and/or grills for food. The skewer support is preferably made in the form of a S-shaped metal section (24) through which a series of vertical holes (25) is drilled passing through the upper part of the S and the intermediate partition (26), thus forming a removable skewer support.

The vertical grills supporting the food are preferably composed of two metal frames (94,95) squeezing a mesh of finer preferably elastic bars forming a matrix to hold the food. This matrix is preferably composed of a mesh of metal wires (96), preferably small stainless steel wires formed in a sequence of plane sinusoidal type waves, placed at regular intervals and interlaced or welded with a second series of identical wires (97) in a direction approximately perpendicular to the first. All these wires are either welded (98) or crimped on the metal frame (99). These two frames may fit one into the other on one side (100,101) or they may be held one in contact with the other by a closure system (102). The dimensions of the grill are preferably adapted such that they can be washed in the dishwasher. The shape of the grill is adapted so as to fit into the U-shaped support.

It is preferable to fit removable click fit or retractable or pivoting handles (111,112) to said grills, to optimise their size to suit the constraints of the dimensions of dishwashers. The handles are preferably retractable or pivoting and when in the storage or cleaning position, they hardly project beyond the surface or even the effective volume of the grill. In one possible embodiment, the ends of the metal frame are formed so as to make two female hinge elements (103,104), and the ends of the handle are formed so as to make male hinge elements (105,106); in a different embodiment, the male and female elements may be inverted. A complementary part (107) is formed to create a blocking position with a hard passage point due to the need for deformation of elements to pass this point. The handles can then be moved from a blocked position (108) (working position) to a free position (109) (cleaning, storage) or any intermediate position (110).

As an example, other example embodiments are shown on FIG. 11 and one sliding embodiment is shown on FIG. 12.

Preferably, each longitudinal end of the grill has a series of notches (27) adjacent to each combustion chamber, preferably at a uniform spacing, designed to form one or more variable height supports for cooking elements such as the rotisserie support, grill support, skewer support, cooking basket support.

Thus, one or several transverse bars (28, 29) can be placed at the required height on each side, these bars themselves acting as a support for the pits, spit turners, rotating baskets and other longitudinal bars (30) used to hang or to fix any food support such as horizontal grills. These horizontal grills are used to cook small food such as mussels or oysters, or when the grill is completely closed, they enable its use as a wood oven to bake bread, pizzas, tarts.

The horizontal grills are supported on said longitudinal bars and may be partially extracted by sliding on each side (FIG. 9). These horizontal grills are made in two preferably foldable parts or parts that can be clamped together to enter a dishwasher. Preferably, these grills are two identical grills (82), composed of a metal frame (83) comprising two shapes (84,85) to clamp one inside the other. Each grill comprises a network of horizontal bars (86), two of which are terminated by shapes (87,88) used to slide on horizontal bars (89,90).

Protection screens (91,92) can be fixed on the front faces of the combustion chambers adjacent to the horizontal grills to prevent excessive direct radiation on food close to the combustion chambers. These screens comprise several openings (93) to improve convection and to redirect radiation.

The vertical food support grills may also be hung through steel supports (31). These supports contain shapes (32) that click fit onto any type of spit or skewer (wood or metal) (33). The shapes (34,35) used to attach this support to the bar are such that this support can be positioned in at least two directions at approximately 90° from each other so as to grill the food on four faces. Finally, these said supports comprise a shape (36) on their upper part so that they can be gripped by a removable handle (37).

This means that the skewers or grills can be handled in complete safety, regardless of the temperature. As a non-limitative example, this handle is composed of a fixed part (39) and a moving part (38) hinged on the mobile part through a hinge pin (40). This mobile part grips the grill support or the skewer support when the handle is used. A spring holds the two parts separated from each other when in the rest position.

One embodiment of the spit (127) has a square section, on which at least two assemblies (128,129) of pins or forks (130,131) are fitted that will rotate the food.

These pin or fork assemblies may be composed of a single stainless steel plate cut into shape and folded so as to form pins, the drive on the square spit (144) and a lock to prevent sliding. This lock is obtained by two additional cut-outs (132,133) with an offset (134) that are re-aligned on the spit by elastic deformation of the shapes (135,136). The efficiency of the lock is directly proportional to the elastic deformation force of these parts. This eliminates traditional tapped guide systems with a locking screw, and these spit forks may also be used on any type of grill.

Other embodiments may consist of a stainless steel plate (137) comprising two folds (138,139) and two notches (140,141) and a cut out (142) such that the shape(s) (143) push or pull the square bar of the spit.

One or more cylindrical metal baskets may be positioned to replace the spit or under the spit, rotating like the spit so as to cook, bake or roast relatively small bulk food. These baskets may preferably be composed of a portion of a cylinder made of a rolled perforated stainless steel plate (119), the complementary part (120) being hinged or clamped to the first part so as to enable filling and thus form a door.

Preferably, each end of the cylinder is closed by a removable clamped shaped sheet metal plate (121,122), that can be used to either suspend the basket with a part of a spit (123,124) or to connect it to a second basket itself adjacent to it (125). These plates are cut out such that they form pins (126) that fit into the perforations of the outside parts of the cylinder made of perforated plate.

The spit turner or basket supports are available in a manual and motor driven version. In the manual version, they are fitted with a lock that holds the spit or basket in place in the required position. For example, this lock may be made from a cut-out metal disk (75) shaped so as to form the support for the spit (76) and a lock near its periphery dependent on its adapted shapes (77). This disk is inserted between two plates: one being fixed (78) and the other adjustable (79) through attachments (80). This disk also supports a handle (81).

Preferably, all elements of the grill that could be scratched or are exposed to heat are made from stainless steel or any other non-corrodible and recyclable material.

Preferably, all elements of the grill that might come into contact with food or cooking residues are removable and/or can be disassembled and are sized so that they can fit into a standard off-the-shelf dishwasher. Preferably, no dimension is larger than 500 mm and if possible the second dimension does not exceed 320 mm.

Preferably, the bottom of the grill is provided with one or more drawers, covering the entire surface of the grill and designed to collect ash (19).

Preferably, the grill is arranged on a carriage preferably comprising two wheels (52,53) and two fixed stands and handles (54,55). The carriage is preferably made from removable elements to reduce its size, for example for long term storage and for moving and delivery. It is composed of a right side (56) and a left side (57), for example made of wood, a low front cross piece (58) and a low back cross piece (59) for example comprising metal wheel shafts.

This carriage is advantageously fitted with a storage drawer (60) and a bottom (61) in its lower part acting as a platform, for example to store the gas container and/or solid fuel reserves and any other utensils necessary for the grill to operate correctly.

Preferably, the grill comprises at least a fold down or removable extension so as to form a work table adjacent to said grill. Advantageously, it comprises an extension on each side of the grill, and the side opposite to the wheels can be fitted with handles. Preferably, one of the extensions can be made from a material for example such as wood used to cut food, and the other from a washable, non-corrodible material that is insensitive to scratches, such as stainless steel. Their shapes may advantageously be designed to recover juice, for example by the presence of channels (74) along the edges of the board. For example, these extensions are composed of a set of metal hinge pins (62,63), two longitudinal wooden members forming the handle on the front (64,65,66,67) and a work surface made of wood forming a cutting table on the back (68), and made of stainless steel on the front (69). The configurations may be identical or they may be inverted.

Preferably, said extensions fold down automatically under the effect of an overload. This overload is calculated to prevent any risk of the grill tipping over, for example under the weight of a child hanging from the end of one of the extensions or an adult accidentally leaning on the end of one of these extensions. Advantageously, these extensions will be held open by gas stays (70,71,72,73), with a resistance force corresponding to this overload. The same gas stays hold the extensions in the folded down position for storage.

Grill combustion chambers are composed of one or several heating elements preferably with different sizes that can be used separately or in combination as explained above. These heating elements can be composed either of radiant gas tubes or electrical resistances or radiant electrical tubes or radiant gas panels or radiant electric panels. Preferably, radiant tubes are arranged as a sort of coil or network.

Preferably, the combustion chambers are composed of almost parallelepiped shaped containers designed to hold solid fuel such as charcoal. These containers (41) are composed of four faces, the bottom, the top and the two sides, made of non-corrodible solid material resistant to heat, such as stainless steel plate.

On the other hand, the top remains open enabling filling at any time and while cooking is taking place, and also enabling evacuation of hot gases and combustion smoke, and thus heating the fuel and causing propagation of the fuel ignition.

Finally, the front face (42) on the containment side of the grill is composed of one or several elements made of non-corrodible materials resistant to high temperature such as refractory stainless steel forming sufficiently large openings to allow maximum direct radiation of incandescent fuel to pass through, but also sufficiently narrow to prevent fuel from flowing towards the grill containment. For example, these openings may be oblong and preferably 20 mm wide and with a pitch of 30 mm. They are preferably placed horizontally so as to slow natural flow of fuel in the container. One preferred embodiment may be a continuous curved stainless steel wire moving backwards and forwards in a vertical plane so as to form a network of parallel wires placed at a uniform spacing (43). The pitch between each wire may vary in height in order to optimise fuel flow factors in the combustion chamber and to prevent fuel from flowing outside the combustion chamber and maximum radiation, for example, the wires may be at a closer spacing at the bottom and at a wider spacing at the top.

Advantageously, the shape of the container is slightly conical, tapered to be wider at the top and narrower at the bottom, which slows flow of the fuel and brings it closer towards the front face. The shape tapers outwards faster near the top part of the container, which combined with the flaps forming an arch that are themselves tapered relative to the container, enables easy filling of the container with fuel even during cooking, the flaps providing protection and preventing pollution of food by fuel or fuel dust. (FIG. 2)

The front face of the container is removable instead of being fixed, and it can be in several parallel vertical positions (48,49) so that the thickness of the container can be varied and therefore the quantity of fuel stored in said container and therefore participating in combustion can also be varied. Therefore, this means that the quantity of fuel affecting cooking can vary as a function of the cooking type to be done and therefore the power involved can also be varied to save fuel for short term cooking. For example, one preferred embodiment may be successive parallel slides (44,45) formed by penetration into the side faces; slides in which the user can easily fit the front face of the container, thus being able to adjust the capacity of said container at will.

The grill is provided with a fast gas ignition system.

One of the possible embodiments is a fixed system composed of two ramps, one under each combustion chamber, each composed of several injectors or nozzles distributed along the length of the combustion chamber and opening into the bottom part of the containers. All that is necessary to ignite the solid fuel is to actuate this system for one or two minutes.

In another preferred embodiment, this system is removable, formed of a manual butane air-gas torch provided with a lance (113) composed of two burners preferably with a flat flame (114,115) mounted opposite to each other at about 180° from each other and approximately perpendicular to the handle of the torch (116). Each burner comprises at least one gas injector (117). The torch can be held in the hand and placed or held in the correct position in the U shape of the fat pan due to the appropriate shape on the lance (118). All that is necessary then is to leave it in this position between 40 and 120 seconds to ignite the combustion chamber over a width of about 150 mm. The user then begins at the centre and repeats the operation once or twice moving the torch outwards and then doing exactly the same on the other side of the grill.

This type of equipment is stored with the gas container on the lower platform of the carriage.

This same equipment may exist with one or several burners and nozzles approximately in line or at a slight angle from the tube of the lance, so that they can be used with grills that do not have two combustion chambers facing each other and close to each other. The total length of the lance and the burner will be between 300 and 500 mm.

A single combustion chamber or a set of combustion chambers (4) may slide over the entire width of the frame, the other combustion chamber or set of combustion chambers (5) is then fixed to the frame by a vertical hinge pin (145) or a set of hinge pins (virtual hinge pin) and at least one removable attachment (146). At the end of cooking, or at any time, said combustion chamber or set of combustion chambers (5) fixed to the chassis may be pivoted at any time by about 180° about the vertical hinge pin (145), the two combustion chambers or set of combustion chambers (4) and (5) being approximately in line with each other, thus forming a double radiant panel that provides very efficient radiant outdoor heating, or a pleasant outdoor fireplace if solid fuel is being used.

An ash recovery pan (147) is placed under the combustion chamber or the set of combustion chambers (5) and at the same time prevents the set from rotating by the use of attachments (148, 149).

This principle is applicable to several combustion chambers or sets of combustion chambers.

1. A barbeque grill comprising:
two vertical combustion chambers at least one of which is adjustable in width and each having a single cooking face facing food to be cooked, wherein the combustion chambers comprise an isolated protection wall in indirect contact with said combustion chambers by circulation of air.

2. The barbecue grill of claim 1, wherein a cooking surface is confined in a closed container formed in part by the combustion chambers.

3. A barbecue grill comprising:
two facing vertical combustion chambers, wherein upper parts of the combustion chambers are prolonged by one or more flaps made from reflecting, removable and/or hinged materials made of at least one part that, when extended, moves towards the heating element facing the flap so as to form an arch.

4. The barbecue grill of claim 3, wherein each side of the combustion chambers at their longitudinal ends is connected by vertical flaps made from a reflecting material, removable and/or hinged in one or several parts, thereby forming a grill containment.

5. The barbecue grill of claim 4, wherein said vertical flaps are not directly accessible from the outside of the combustion chambers due to the presence of an isolated protection wall that indirectly contacts said combustion chambers.

6. The grill in claim 3, wherein said combustion chambers comprise at least 2 compartments or two heating elements that can be used separately or in combination so as to modulate a heating area therebetween.

7. The grill of claim 3, comprising at least one removable fat pan independent of the combustion chambers.

8. The grill of claim 7, wherein said removable fat pan comprises a U-shaped support facing upwards to hold a skewer support and/or a grill cooking surface.

9. The grill of claim 8, wherein the skewer support is in the form of an S-shaped metal section through which a series of vertical holes are drilled to pass through the upper part and the intermediate partition of the S.

10. The grill of claim 3, comprising at least one notch disposed at a longitudinal end adjacent to each combustion chamber, intended to form one or more variable height supports for a cooking element.

11. The grill of claim 3, comprising at least one horizontal rack installed between the two combustion chambers, and is fixed or partially removable by sliding.

12. The barbecue grill of claim 11, comprising at least one radiation protection screen installed on each of the combustion chambers, adjacent to the horizontal racks.

13. The barbecue grill of claim 3, wherein a skewer, a grill cooking surface, a fat pan or a spit, which contacts food or cooking residues, are removable and/or adapted to be disassembled, and are sized to fit into a dishwasher.

14. The barbecue grill of claim 3 comprising:
a carriage; and
at least one fold-down or removable extension connected to said carriage, wherein said extension folds down automatically when overloaded.

15. The barbecue grill of claim 3, comprising heating elements heated by gas, electricity or a solid fuel.

16. The barbecue grill of claim 15, when the solid fuel is used for heating, wherein a heating area and/or a radiant area of said combustion chambers is provided with openings, placed horizontally so as to slow the downward movement of the solid fuel in the combustion chamber.

17. The barbecue grill of claim 16, wherein said openings are variable in height and/or elongated.

18. The barbecue grill of claim 15, wherein said combustion chambers form a conical-like shaped container, tapered to be wider at the top and narrower at the bottom, which slows the downward movement of the solid fuel in the combustion chamber and/or the top part of said container remains open and is tapered to facilitate filling of the container with the solid fuel.

19. The barbecue grill of claim 18, wherein said heating and/or radiant area is removable from said combustion chamber so the thickness of the container and the quantity of solid fuel stored in said container can be varied.

20. The barbecue grill of claim 16, comprising: at least one fixed or removable gas ignition system.

21. The barbecue of claim 4, wherein the vertical combustion chamber, comprises metallic supports used to suspend vertical food support racks and to attach a spit and to suspend the spit in at least two directions.

22. The barbecue grill of claim 21, wherein the racks The barbecue grill of claim 21, wherein are fitted with removable, clampable, retractable or pivoting handles.

23. The barbecue grill of claim 22, wherein the racks include a mesh of first metal wires formed in a sequence of plane sinusoidal type waves, placed at regular intervals, and interlaced or welded with a second series of identical wires in a direction approximately perpendicular to the first metal wires.

24. The barbecue grill of claim 21, wherein one or more cylindrical metallic baskets are positioned to replace the spit or around the spit, rotating like the spit.

25. The barbecue grill of claim 21, wherein forks of the spit are made from a single piece of sheet metal cut-out and folded so as to form entrainment, guide and longitudinal lock.

26. The barbecue grill of claim 3, comprising at least one combustion chamber or set of hinged combustion chambers rotatable to transform said grill into an outdoor radiant heater, or an outdoor fireplace.
